(19) United States
(12) Patent Application Publication
(10) Pub. No.: US 2009/0302614 A1
(43) Pub. Date: Dec. 10, 2009

(54) WIND AND UPDRAFT TURBINE

(75) Inventor: Barry Ross Ireland, Moosomin (IE)

Correspondence Address: FULBRIGHT & JAWORSKI L.L.P, 2200 ROSS AVENUE, SUITE 2800, DALLAS, TX, 75201-2784, US

(73) Assignee: BRI Energy Solutions Limited, Moosomin, SK (CA)

(21) Appl. No.: 12/298,472

(22) PCT Filed: Apr. 20, 2007
(86) PCT No.: PCT/CA2007/000665

§ 371 Date: Feb. 11, 2009

Related U.S. Application Data
(60) Provisional application No. 60/794,094, filed on Apr. 24, 2006.
(60) Provisional application No. 60/869,860, filed on Dec. 13, 2006.

(51) Int. Cl. F03D 9/00; F03D 3/06

(52) U.S. Cl. 290/55

(57) ABSTRACT

The invention relates to the field of electrical generation and more specifically to the use of a wind turbine for generating electricity. A vertical axis wind turbine is mounted on the upper portion of a chimney. Rotor blades are disposed on the outside of the chimney and the mechanical energy produced by the rotating rotor blades is transferred to a generator by means of a short drive shaft. The drive shaft is used to drive the rotor within the generator to induce a voltage in the stator. In an alternate configuration, the wind turbine and generator are integrated. The rotor blades are coupled directly to a rotating, current inducing set of permanent magnets or rotor for rotation about a stationary, current generating stator. In either configuration, the rotor blades are rotated using the updraft associated with the chimney or the prevailing wind.

### TECHNICAL FIELD

The invention relates to the field of electrical generation and more specifically to the use of a wind turbine for generating electricity.

### BACKGROUND ART

As those skilled in the art are aware, the availability of energy sources such as coal, oil and natural gas are limited which has resulted in escalating costs for such fuels. This rising cost is significant for residential users and even more significant for commercial users such as manufacturers where such costs could mean the difference between continued operation and bankruptcy.

As a result of such rising costs, there have been intensive initiatives to develop alternate energy sources, a sub-group of which includes renewable energy sources which capture their energy from ongoing natural processes such as sunshine, wind, flowing water, biological processes and geothermal heat flows. Renewable energy sources may be used directly or used to create other more convenient forms of energy. An example of direct use would include geothermal, while an example of indirect use would include a wind turbine used to generate electricity.

A wind turbine may be attached to an electrical generator to produce electricity. Wind turbines can be separated into two general types based on the axis (either horizontal or vertical) about which the turbine rotates. With a vertical axis wind turbine (VAWT), the generator is typically placed at the bottom of the tower on which the VAWT is mounted so that the tower doesn't need to support it. As shown in FIG. 1, VAWT 10 mounted to tower 20 is connected to generator 30 which may store the electricity produced, for example, in capacitor or battery 40 or distribute it directly to residential or commercial end user 50. VAWTs have been designed for residential and commercial use such as the 2.5 kW VAWT offered by Cleanfield Energy Corp. of Mississauga, Ontario, Canada. As shown in FIG. 2, this proprietary VAWT features three narrow, three-metre vertical blades 60 that rotate about central axis 70.

A solar chimney is an apparatus for harnessing solar energy by convection of heated air. In its simplest form, it consists of a black-painted chimney. During the daytime, solar energy heats the chimney, thereby heating the air within it, resulting in an updraft of air within the chimney. A solar tower incorporates solar collectors placed at the bottom of the chimney to warm air near the collectors. The resulting warm air creates an updraft in the chimney. In one configuration of a solar tower, a wind turbine is placed in the chimney and driven by the rising air. The turbine is connected to a generator, thereby producing electricity for storage or distribution. German Patent DE 198 21 659 entitled “Power Station Using Updraft Flowing Up Tall Chimney”, filed May 14, 1998 and invented by Manfred Fischer describes such a configuration. Referring to FIG. 3, the Abstract of this patent states that an updraft power station consists of a chimney (B) whose foot is surrounded by a solar energy collector roof (A) and releases the air flow from the disc-shaped annular chamber under the roof to the chimney. There is at least one wind turbine (C) arranged in this air flow.

Both the VAWT and solar tower or chimney are capable of adequately producing electricity in their own right, but they are both limited by design. More specifically, the VAWT must have wind in order to operate which restricts its use to specified geographical areas where there is consistent wind. The solar chimney relies on sunlight to produce sufficient updraft to drive the wind turbine so its use is also geographically limited. A wind turbine which could operate in a wide variety of climates would be ideal.

### DISCLOSURE OF INVENTION

The present invention seeks to overcome the deficiencies of the prior art by providing a vertical axis wind turbine mounted on the upper portion of a chimney. Rotor blades are disposed on the outside of the chimney and the mechanical energy produced by the rotating rotor blades is transferred to a generator by means of a short drive shaft. More specifically, if an alternator (i.e. and alternating current (AC) generator) is used, the drive shaft is used to drive the AC field windings or rotor which rotates within the generator armature windings or stator. Alternately, the wind turbine and generator are integrated. The rotor blades are coupled directly to a rotating, current inducing set of permanent magnets or rotor for rotation about a stationary, current generating stator.

Certain exemplary embodiments provide a wind turbine mountable at or near an upper portion of a chimney, or forming an integral component of an upper portion of the chimney, the wind and updraft turbine comprising: a blade mounting rotor hub coupled to a collar rotatable about the upper portion of the chimney, about an axis at least substantially in line with a main axis of the chimney; and at least two wind-engaging rotor blades extending outwardly from the rotatable blade mounting rotor hub, wherein each of the at least two wind-engaging blades are movable upon application thereto of an air movement about the chimney selected from at least one of the group consisting of: (i) an updraft about an interior of the chimney; (ii) an updraft about an exterior of the chimney; and (iii) a prevailing wind. Preferably, a generator is operably linked to the rotatable collar for converting mechanical energy produced by the rotatable collar into electrical energy.

Certain other exemplary embodiments may provide a wind and updraft turbine mountable at or near an upper portion of a chimney, or forming an integral component of an upper portion of the chimney, the wind and updraft turbine comprising: a current inducing rotor comprising a current inducing set of permanent magnets rotatable about the upper portion of the chimney, about an axis at least substantially in line with a main axis of the chimney; a stationary, current generating stator comprising at least one wound coil about which the rotor rotates, wherein the rotor generates a magnetic field which passes in close proximity to the at least one wound coil; and at least two wind-engaging rotor blades extending outwardly from an outer casing associated with the rotor, wherein each of the at least two wind-engaging blades are movable upon application thereto of an air movement about the chimney selected from at least one of the group consisting of: (i) an updraft about an interior of the chimney; (ii) an updraft about an exterior of the chimney; and (iii) a prevailing wind.

Still certain other exemplary embodiments may provide a wind and updraft turbine mountable at or near an upper portion of a cylindrical pole, the wind and updraft turbine comprising: a current inducing rotor comprising a current inducing set of permanent magnets rotatable about the upper portion of the cylindrical pole, about an axis at least substantially in line with a main axis of the cylindrical pole; a stationary, current generating stator comprising at least one wound coil about which the current inducing rotor rotates, wherein the current inducing rotor generates a magnetic field which passes in close proximity to the at least one wound coil; and at least two wind-engaging rotor blades extending vertically from an outer casing associated with the current inducing rotor, wherein each of the at least two wind-engaging blades are movable upon application thereto of a prevailing wind.

The advantages of the invention are now readily apparent. The wind turbine of the present invention can generate electricity using the updraft associated with the chimney or from the prevailing wind. The present invention makes use of existing structures (e.g. smoke stacks on factories or refineries, natural gas well burn off stacks, apartment buildings chimneys, telephone poles, etc,) allowing wind turbine owners to be at least partially self-sufficient for their supply of electricity. Additionally, the need for power distribution lines running for several miles from generator stations to factories or residences is eliminated.

### BRIEF DESCRIPTION OF THE FIGURES

The invention will now be described in relation to the following drawings in which:

FIG. 1 depicts a prior art electricity generation system using a vertical axis wind turbine;

FIG. 2 depicts a prior art vertical axis wind turbine which may be used in the system of FIG. 1;

FIG. 3 depicts a prior art solar tower with integral wind turbine;

FIG. 4 depicts a typical factory stack on which the present invention may be mounted;

FIG. 5 depicts an exploded view of the stack of FIG. 4 with a first embodiment of the present invention mounted thereon;

FIG. 6 depicts a functional block diagram of an alternator;

FIG. 7(a) depicts an exploded view of the stack of FIG. 4 with a second embodiment of the present invention mounted thereon;

FIG. 7(b) depicts a top view of the second embodiment of FIG. 7(a);

FIG. 7(c) depicts the second embodiment of FIG. 7(a) with the rotor blades running parallel to the stack;

FIG. 7(d) depicts in greater detail the stator of the embodiments of FIGS. 7(a) and 7(c);

FIG. 7(e) depicts in greater detail the rotor of the embodiments of FIGS. 7(a) and 7(c);

FIG. 7(f) depicts in greater detail the rotor blades of the embodiment of FIG. 7(c);

FIGS. 8(a) to 8(c) depict a variation of the embodiment of FIGS. 7(a) to 7(f);

FIG. 8(d) depicts a variation of the embodiment of FIG. 8(c);

FIGS. 9(a) to 9(l) depict various blade configurations which may be used in the wind turbine of the present invention;

FIG. 10 depicts the operation of the present invention; and

FIG. 11 depicts a wind turbine in accordance with the present invention with a venturi incorporated therein.

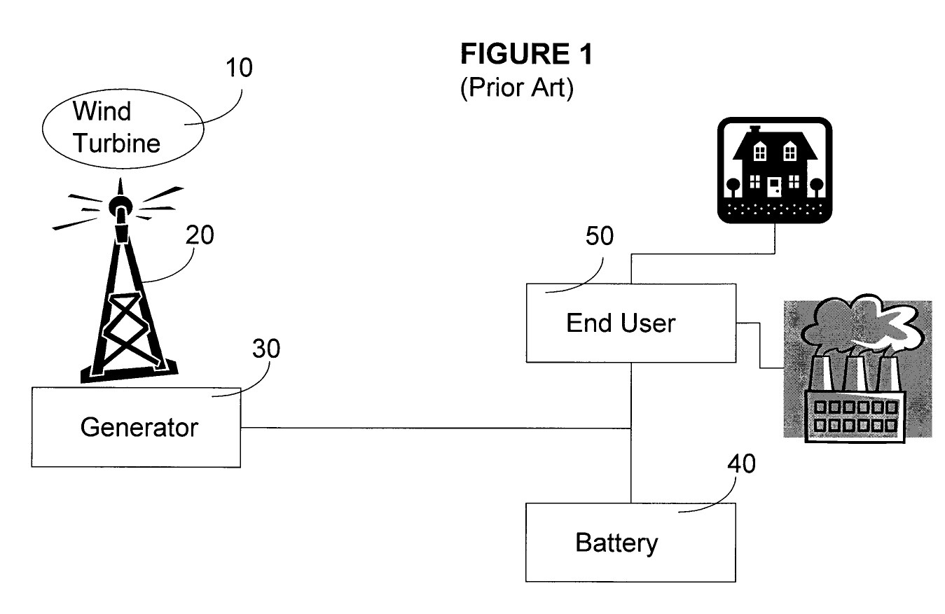

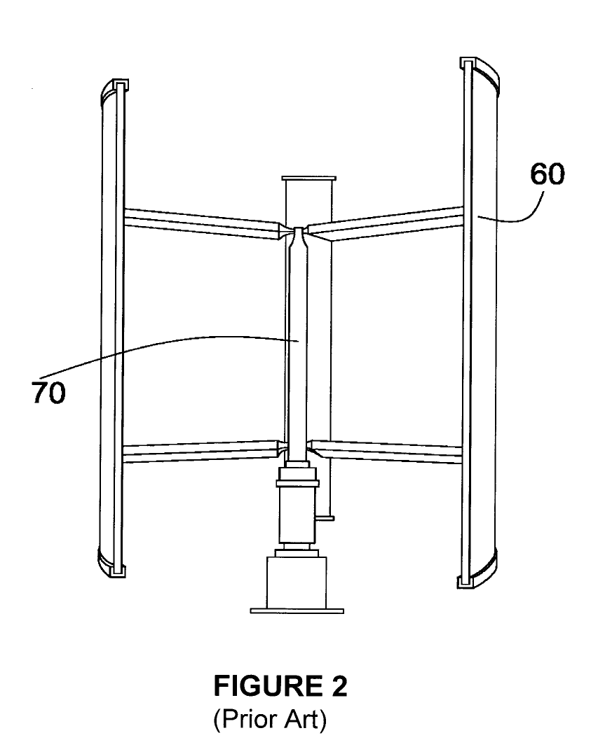

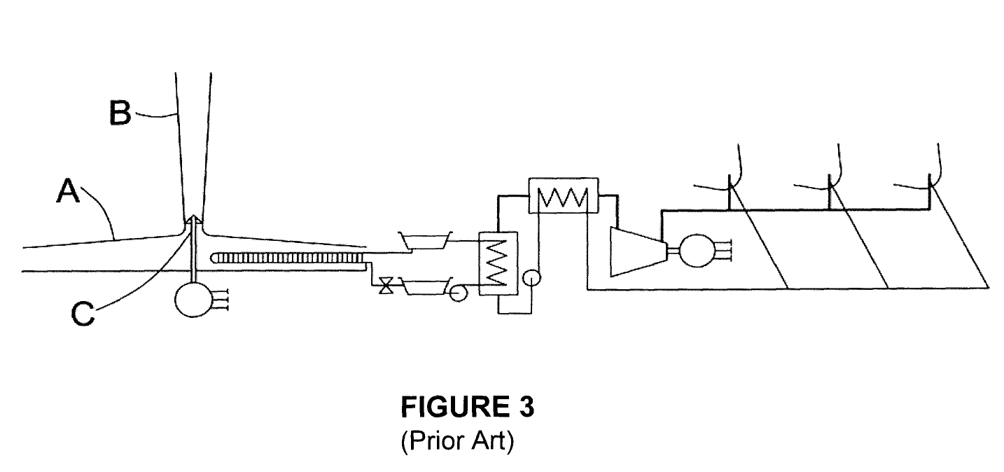

### BEST MODES FOR CARRYING OUT THE INVENTION

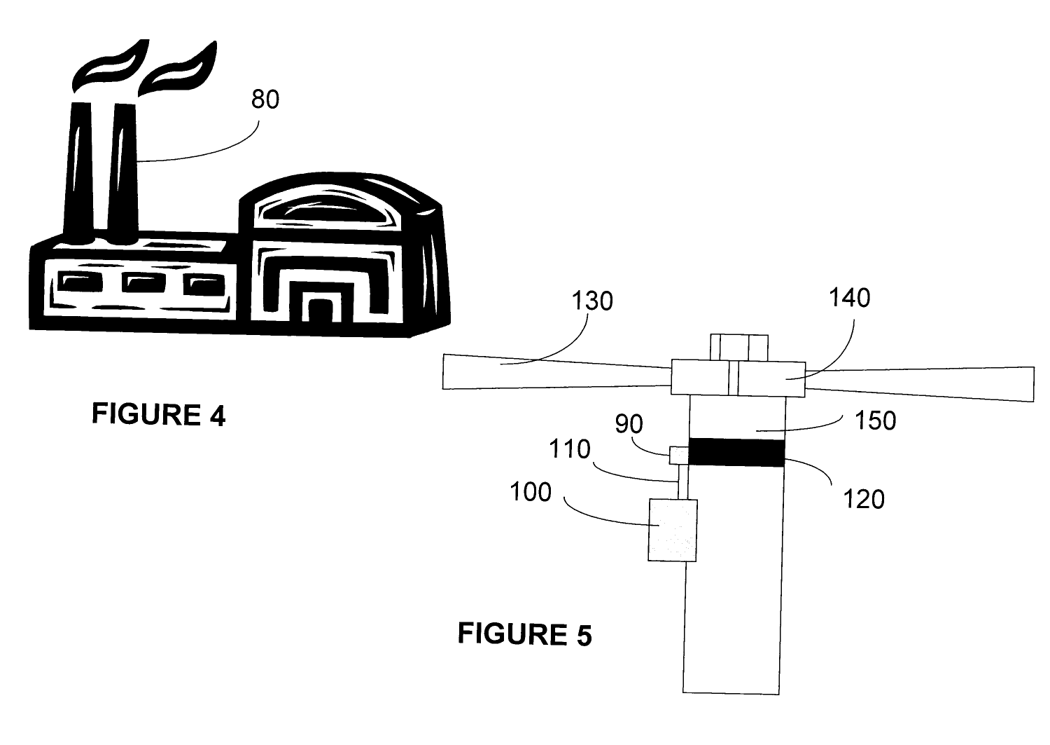

FIG. 4 depicts a typical factory chimney or smoke stack 80 on which the present invention may be mounted. FIG. 5 depicts a first embodiment of the present invention. As can be seen in the figure, generator drive wheel 90 connects to generator 100 through drive shaft 110. A serpentine belt 120 moves generator drive wheel 90. The size differential between generator drive wheel and serpentine belt 120 causes drive shaft 110 to rotate at relatively high revolutions per minute (RPMs), possibly in the range of 1500 RPM. Drive shaft 110 may be optionally fitted with an emergency mechanical brake (not shown). As will be understood by this in the art, the drive mechanism is not limited to serpentine belt 120. A drive chain and cog arrangement could be substituted to rotate drive shaft 110 and the invention is meant to include such alternate drive mechanisms.

Serpentine drive belt 120 is driven by wind-engaging rotor blades 130 which capture the updraft or wind and transfer its power to rotor hub 140. Rotor hub 140 is attached to collar 150 which is rotatably mounted at or near the discharge end of smoke stack 80. Serpentine drive belt 120 is mechanically coupled to collar 150 extending around the circumference of smoke stack 80. It should be appreciated that rotor blades 130 and rotor hub 140 to which they are attached, are often referred to in the industry as the rotor. This is not to be confused with the rotor integral to generator 100 which will be discussed in more detail below.

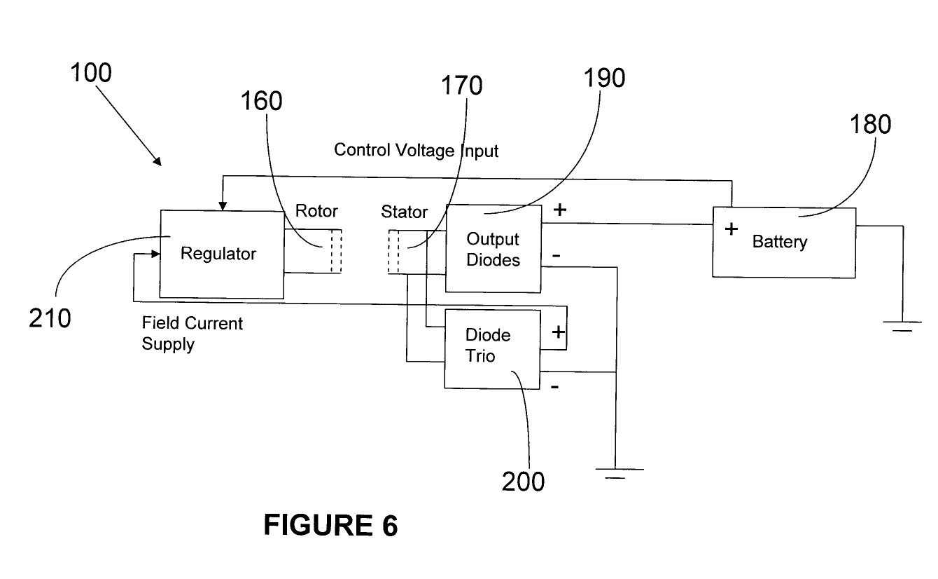

As understood by those in the art, electrical generator 100 is a device that produces electrical energy from a mechanical energy source. An alternator is a generator that converts mechanical energy to alternating electrical current. When the magnetic field around a conductor changes, current or energy is induced in the conductor. Referring to FIG. 6, in a typical alternator (labeled generally as 100), a rotating magnet or rotor 160 turns within stator 170, a stationary set of conductors wound in coils on an iron core. When rotor 160 rotates, its magnetic field cuts across the conductors (or windings) of stator 170, generating electrical current or energy, as the mechanical input causes the rotor to turn. The magnetic field of rotor 160 may be produced by a rotor winding energized with direct current (i.e. a field current) through slip rings and brushes. If a direct current output is desired (e.g. to charge a battery 180), the alternating current voltage is converted by output diodes 190 into pulsating direct current voltage. Additionally, to regulate the field current delivered to rotor 160, diode trio 200 may be used to provide field current to a regulator 210 with a control voltage input from the battery being used to determine if more or less field current is required to increase or decrease the magnetic field strength of rotor 160.

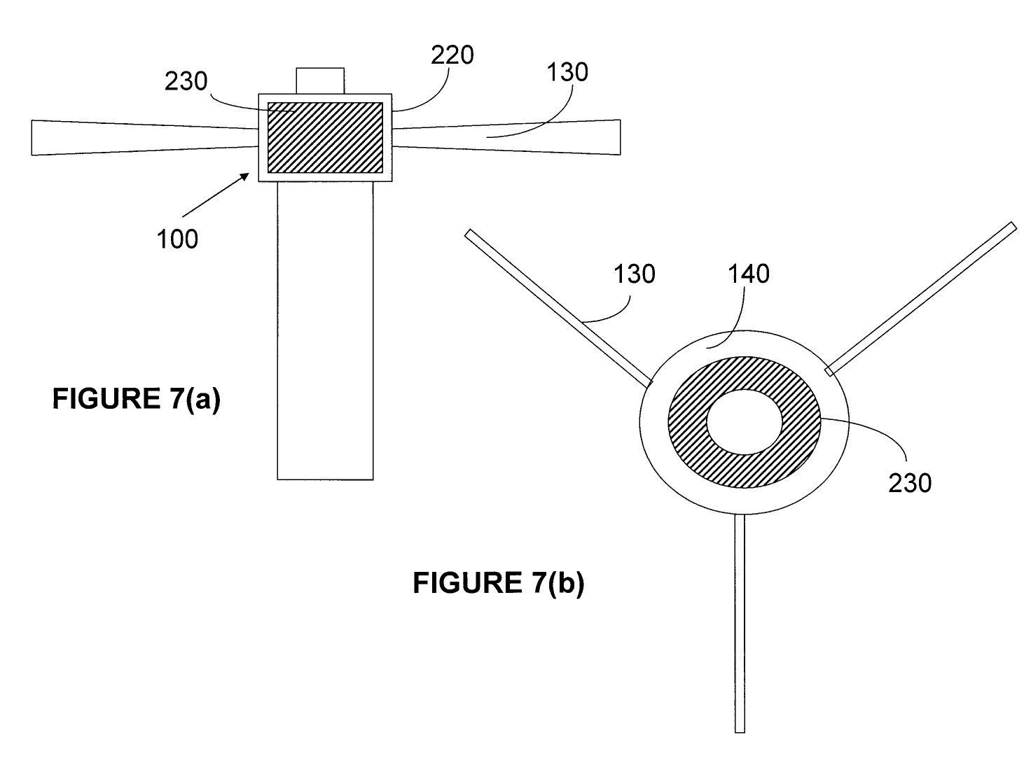

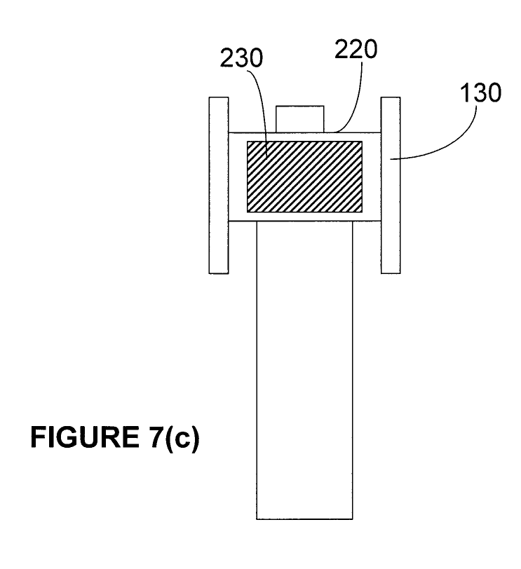

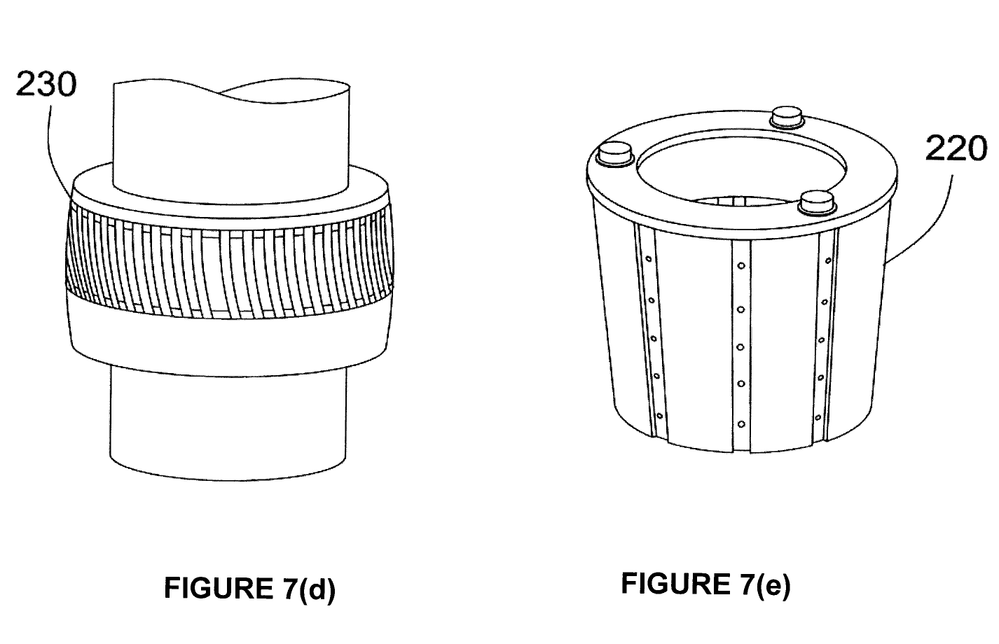

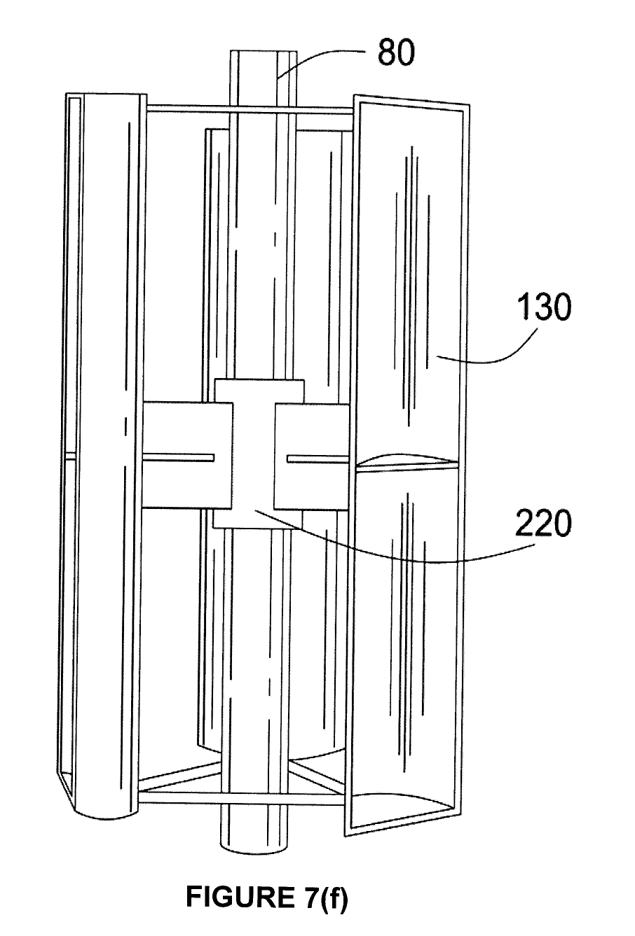

FIGS. 7(a) and 7(b) depict a second embodiment of the present invention. In this configuration, generator 100 is integrated within the wind turbine at the top of smoke stack or chimney 80. In this embodiment, rotor blades 130 are coupled directly to a rotating, current inducing set of permanent magnets or rotor 220 for rotation about a stationary, current generating stator 230. The outer casing of rotor 220 includes bearings (not shown) positioned at the top and bottom which allow rotor 220 to rotate smoothly about stator 230. Similar to a traditional generator, the permanent magnets produce a magnetic field. However, rotor 220 rotates around stator 230. When the magnetic field of rotor 220 cuts through the conductors of stator 230, a voltage is induced in the conductors. Stator 230 may be wound for single phase or three phase alternating current generation as is well known in the art. The key advantage of this configuration is that the need for a driveshaft to link collar 150 to generator 100 is avoided. The number of moving parts is thereby reduced which serves to lower maintenance costs and minimize downtime of the wind turbine. FIG. 7(c) depicts the second embodiment of FIG. 7(a) with rotor blades 130 running parallel to the stack. This blade configuration works well in certain wind situations. More specifically, in the presence of a horizontal wind, with the vertical blades positioned close to smoke stack or chimney 80 the rotational speed of rotor blades 130 is increased as a result of the higher velocity air flow which arises when the wind strikes smoke stack or chimney 80. Increased rotational speed translates directly to increased horsepower (hp) in generator 100. Additionally, increased rotational speed of the rotor blades results in the speed of air in the updraft (as will be discussed below) along smoke stack or chimney 80 also being increased. It should be appreciated that the wind turbine of FIG. 7(c) could be mounted on any cylindrical pole which is exposed to sufficient horizontal wind to drive rotor blades 130 i.e. it is not restricted to being mounted on smoke stack or chimney 80.

FIGS. 7(d) and 7(e) depict in greater detail the rotor and stator of the embodiments shown in FIGS. 7(a) and 7(c). More specifically, the current generating stator 230 is depicted in FIG. 7(d), while the current inducing set of permanent magnets or rotor 220 is depicted in FIG. 7(e). FIG. 7(f) highlights in greater detail rotor blades 130 which are removably attached to rotor 220.

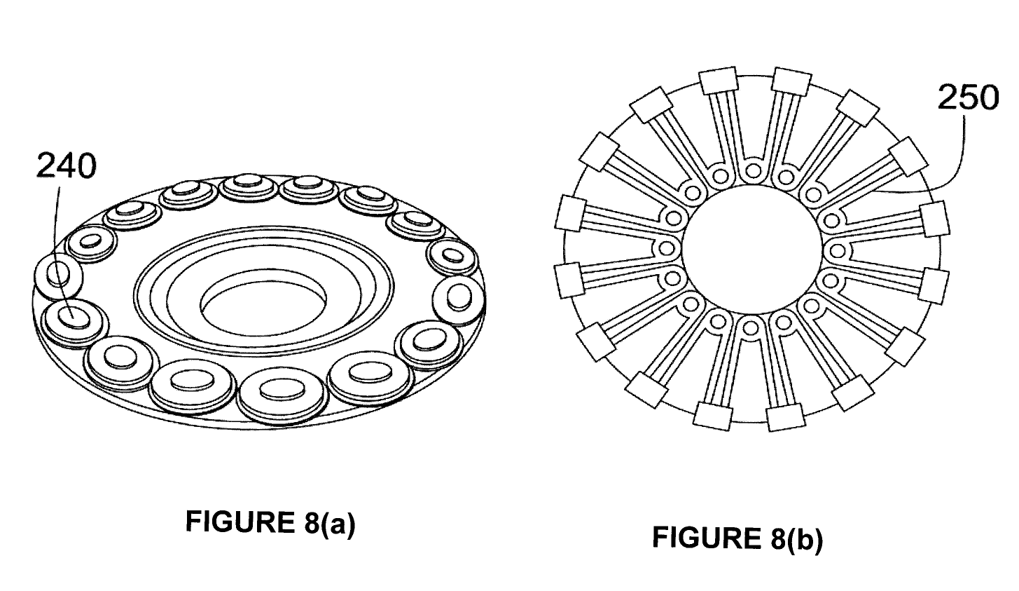

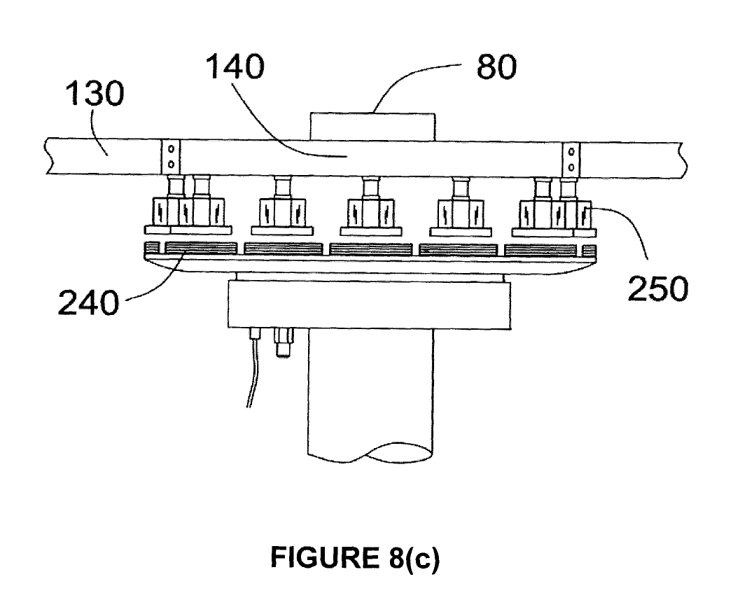

FIGS. 8(a) to 8(c) depict a variation of the embodiment of FIGS. 7(a) to 7(c). In this variation, a circular array of wound coils 240 (see FIG. 8(a)), is rigidly fixed to smoke stack or chimney 80, while a circular array of permanent magnets 250 is positioned above, and in close proximity to, wound coils 240. Permanent magnets 250 rotate about smoke stack or chimney 80 on bearings (not shown). FIG. 8(c) depicts the variation in assembled form which highlights the horizontally disposed wound coils 240 attached to smoke stack or chimney 80. Permanent magnets 250 are also horizontally disposed and are attached to rotor hub 140 for rotation about smoke stack or chimney 80 in close proximity to wound coils 240. Permanent magnets 250 are magnetically coupled to wound coils 240. More specifically, when the magnetic field associated with permanent magnets 250 cuts across the windings of wound coils 240 an electrical current is generated which can be stored or directly distributed to end customers. FIG. 8(d) depicts a variation of the embodiment of FIG. 8(c) in which rows of horizontally disposed wound coils 240 are layered with and in close proximity to rows of horizontally disposed permanent magnets 250. Similar to the embodiment of FIG. 8(c), horizontally disposed wound coils 240 are attached to smoke stack or chimney 80, while horizontally disposed permanent magnets 250 are attached to rotor hub 140. Rotor blades 130 (not shown) are removably attached to rotor hub 140, thereby allowing horizontally disposed permanent magnets 250 to rotate together upon movement of rotor blades 130 (not shown).

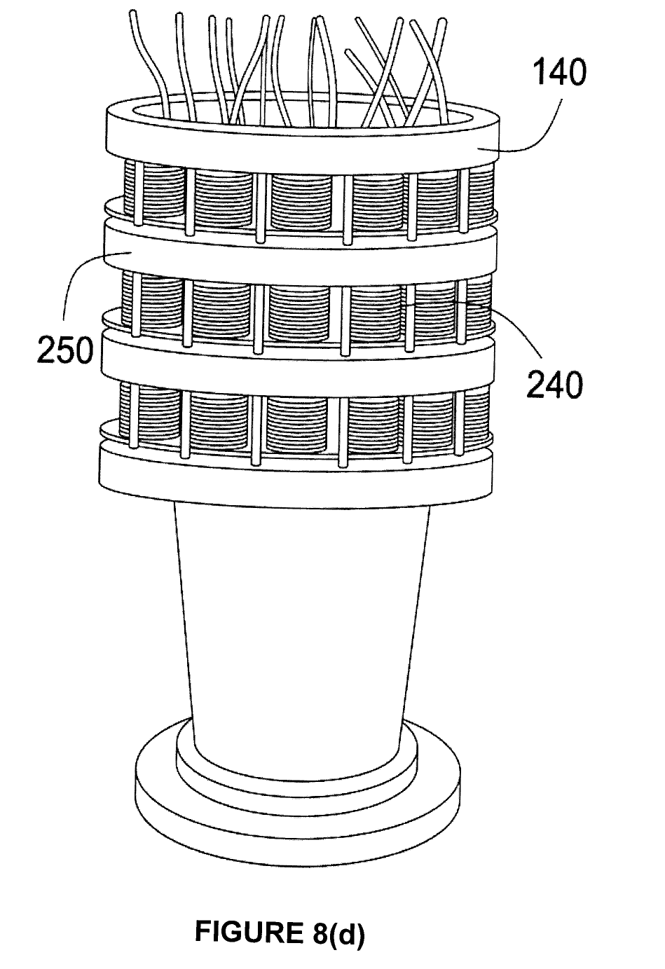

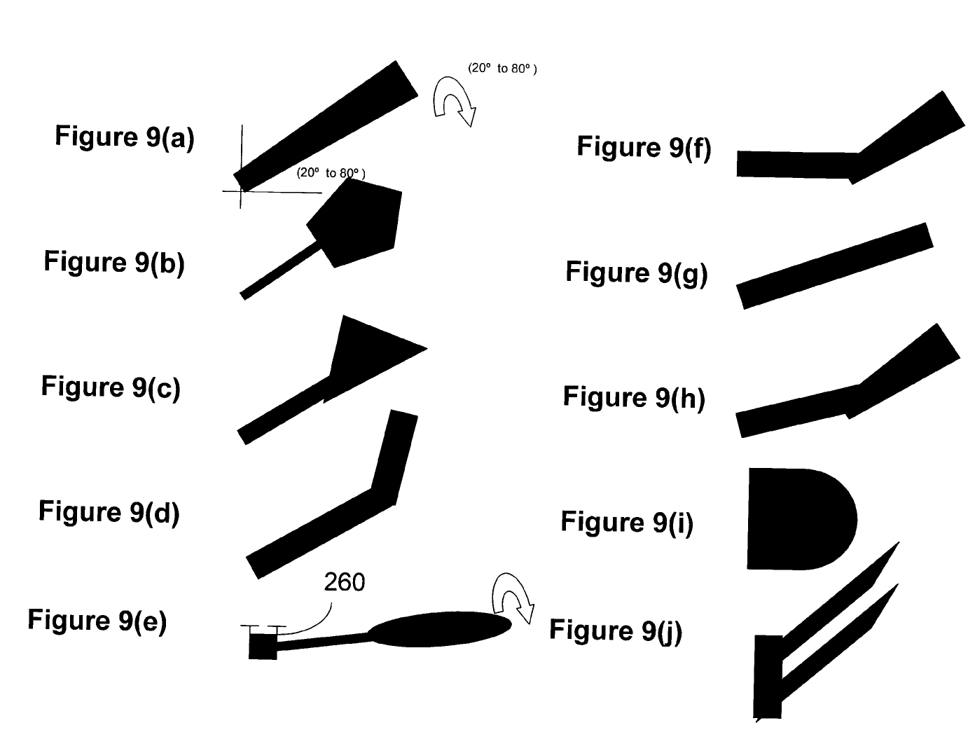

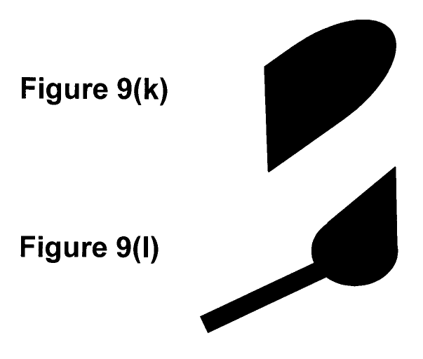

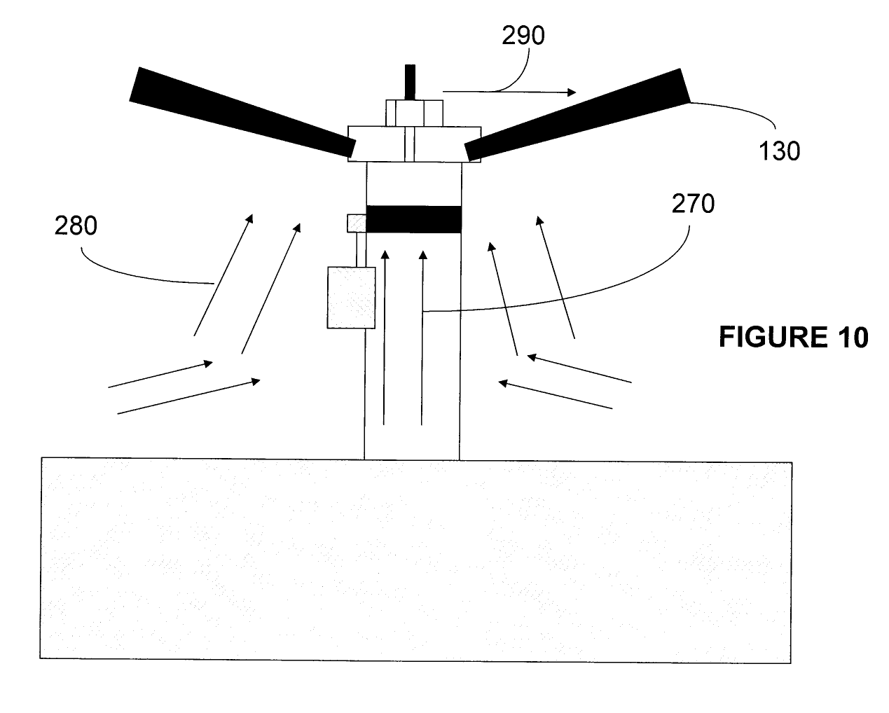

As depicted in FIGS. 9(a) to 9(l) a number of configurations for rotor blades 130 may be used with the wind turbine of the present invention. In terms of the number of blades present, there may be anywhere from two to thirty depending on a number of factors including turbine stability issues, the wind forces in the area, and the amount of electricity to be generated. As will be appreciated by those in the art, the number and shape of rotor blades 130 may be effectively used to rotate the wind turbine at a high or low speed. Referring to the figures, a variety of shapes are possible, each of which will offer different performance characteristics. In general, rotator blades 130 are vertically angled between 40° and 60°, although rotor blades may be disposed vertically as discussed in relation to FIG. 7(c). FIG. 9(a) depicts a blade which may be vertically inclined between 20° and 80° and laterally tilted between 20° and 80°. FIG. 9(e) depicts an adjustable blade configuration in which screws 260 allow the blade to be rotated to adjust its pitch or moved vertically to adjust its angle of inclination with respect to smoke stack 80.

As those in the art will appreciate, there are two basic types of airfoils (i.e. rotor blades 130) used in wind turbines: a lifting type; and a drag type. With the drag style airfoil rotor blades 130 are generally a flat plate which the wind hits and causes to rotate. This type of design is great for very low wind areas and will develop a lot of torque to perform an operation (such as turning a shaft connected to generator 100). However, in medium to higher winds, their capabilities to produce energy are limited. The lifting style airfoil is generally used in most modern horizontal axis wind turbines (HAWTs) and has the general shape of an airplane wing to facilitate lift in accordance with well understood aerodynamic principles. A properly designed lifting airfoil is capable of converting significantly more power in medium and higher winds. Additionally, only a few blades (i.e. three) are used to achieve the greatest efficiency. As can be seen from FIGS. 9(a) to 9(l) the blades of the present invention are of both the drag and lift type.

In addition to wind directly striking rotor blades 130, rotor blades 130 are designed to take advantage of the updraft created by: (a) hot emissions from smoke stack 80; (b) heating of the air adjacent the exterior surface of smoke stack 80 by conduction of internal heat in smoke stack 80; (c) heating of air within smoke stack 80 and adjacent the exterior surface of smoke stack 80 by solar radiation; and (d) wind hitting and being forced upwards along the exterior of smoke stack 80 i.e. an updraft. With respect to (c), it should be appreciated that even when smoke stack 80 is not in operation discharging waste emissions, it can nonetheless be used to create an updraft. Similar to the operation of the solar chimney discussed in the background section, if smoke stack 80 is painted a dark colour, the sun will heat the air inside smoke stack 80 and the air along the exterior of smoke stack 80, causing it to rise and create an updraft.

The diameter of smoke stack 80 can vary from 1 inch to 25 feet, while the height of smoke stack 80 can vary from 10 feet to 1000 feet. It should also be appreciated that the present invention can be adapted for both industrial and residential applications i.e. fitted on any stack where an updraft can be created to drive rotor blades 130. In the present invention, the shapes and angles of rotor blades 130 will vary depending on the configuration of smoke stack 80. For example, if smoke stack 80 is located in an area where there are several stacks, there will be more updraft and less prevailing wind, while a single smoke stack 80 will have less updraft and more prevailing wind. In either situation, the updraft and/or prevailing wind can be used to generate power. In the event that there is no prevailing wind, the updraft can power the wind turbine of the present invention independently. Alternately, if the factory is not in operation such that there is no discharge from smoke stack 80, solar heating of smoke stack 80 and/or the prevailing wind can independently drive the wind turbine.

As can be seen in FIG. 10, in operation heated air or emissions 270 rise up smoke stack 80 to create an updraft. Simultaneously, either wind striking smoke stack 80 or heated air adjacent smoke stack 80 (shown generally at 280) also rises to intersect rotor blades 130. Additionally, prevailing wind 290 strikes rotor blades 130 to further assist with the rotation of collar 150. It should also be noted that heated air or emissions 270 will also aid in creating an updraft along smoke stack 80 as the evacuated air above rotor blades 130 will pull air through rotor blades 130. As will be appreciated, to the extent that the blade configuration shown in FIG. 7(c) is used, prevailing wind 290 will be the major force causing rotor blades 130 to rotate since the updraft has limited effect on blade movement.

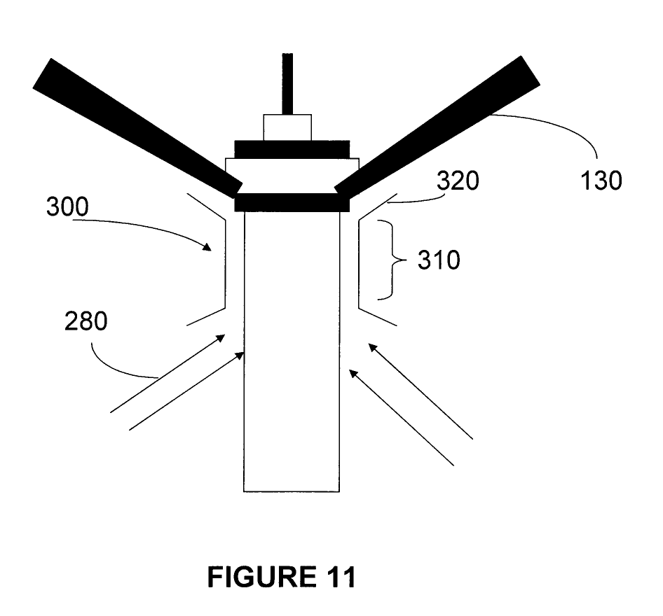

As shown in FIG. 11, a wind turbine in accordance with the present invention may also incorporate a wind deflector or venturi 300 in the form of a concentric tube which is constricted in the middle 310 and flared on both ends 320. The cross-section of venturi 300 is depicted to facilitate description of this feature. As will be appreciated, the velocity of the wind or heated air 280 arriving at the venturi entrance will increase as it passes through the constricted portion 310 of the concentric tube. The air having the increased velocity will exit the venturi 300 and pass through rotor blades 130, thereby causing them to rotate faster.

Although the present invention has been fully described by way of the examples with reference to the accompanying drawings, it is to be noted that various changes and modifications will be apparent to those skilled in the art. Therefore, unless such changes and modifications otherwise depart from the spirit and scope of the present invention, they should be construed as being included therein. For example, as highlighted above in relation to FIG. 7(c), although the present invention may be preferably mounted on chimney or smoke stack 80, it could also be mounted on any cylindrical pole e.g. a telephone pole. In this configuration, rotation of rotor blades 130 is accomplished primarily from the prevailing wind.

### INDUSTRIAL APPLICABILITY

The wind turbine of the present invention can generate electricity using the updraft associated with a chimney or from the prevailing wind. The present invention makes use of existing structures (e.g. smoke stacks on factories or refineries, natural gas well burn off stacks, apartment buildings chimneys, telephone poles, etc,) allowing wind turbine owners to be at least partially self-sufficient for their supply of electricity.

1. A wind and updraft turbine mountable at or near an upper exterior portion of a chimney, or forming an integral component of an upper exterior portion of said chimney, said wind and updraft turbine comprising:
a rotor hub coupled to a collar rotatable about said upper exterior portion of said chimney, about an axis at least substantially in line with a main axis of said chimney; and
at least two wind-engaging rotor blades extending outwardly from said rotatable rotor hub, wherein each of said at least two wind-engaging blades are movable upon application thereto of an air movement about said chimney selected from at least one of the group consisting of:
(i) an updraft about an interior of said chimney;
(ii) an updraft about an exterior of said chimney; and
(iii) a prevailing wind.

2. The wind and updraft turbine of claim 1 wherein a generator is operably linked to said rotatable collar for converting mechanical energy produced by said rotatable collar into electrical energy.

3. The wind and updraft turbine of claim 2 wherein said generator is mounted on an exterior surface of said chimney, and wherein said rotatable collar further comprises a serpentine drive belt extending about a circumference of said rotatable collar, and wherein a drive shaft rigidly attached to a rotor integral to said generator is rotated by said serpentine drive belt.

4. The wind and updraft turbine of claim 3, wherein said at least two wind-engaging blades are mounted with rotational symmetry about said rotatable rotor hub.

5. The wind and updraft turbine of claim 4, wherein each of said at least two wind-engaging blades are vertically inclined at an angle of from about 20 to 80 degrees relative to a plane of rotation of said rotatable rotor hub.

6. The wind and updraft turbine of claim 5, wherein each of said at least two wind-engaging blades is laterally tilted an tilted at an angle of from about 20 to 80 degrees relative to a plane of rotation of said rotatable rotor hub.

7. The wind and updraft turbine of claim 1, wherein said updraft is caused by any one or more of:
(a) hot emissions from said chimney;
(b) heating of air adjacent said exterior surface of said chimney by conduction of internal heat in said chimney;
(c) heating of air within said chimney and adjacent said exterior surface of said chimney by solar radiation; and
(d) wind hitting and being forced upwards along said exterior of said chimney.

8. The wind and updraft turbine of claim 1 wherein a venturi is vertically mounted on said chimney to facilitate said updraft about said exterior of said chimney.

9. The wind and updraft turbine of claim 1 wherein the diameter of said chimney is between a range of approximately 1 inch to 25 feet, and wherein said wind turbine is adaptable to chimneys within said range.

10. A wind and updraft turbine mountable at or near an upper exterior portion of a chimney, or forming an integral component of an upper exterior portion of said chimney, said wind and updraft turbine comprising:
a current inducing rotor comprising a current inducing set of permanent magnets rotatable about said upper exterior portion of said chimney, about an axis at least substantially in line with a main axis of said chimney;
a stationary, current generating stator comprising at least one wound coil about which said rotor rotates, wherein said rotor generates a magnetic field which passes in close proximity to said at least one wound coil; and
at least two wind-engaging rotor blades extending outwardly from an outer casing associated with said rotor, wherein each of said at least two wind-engaging blades are movable upon application thereto of an air movement about said chimney selected from at least one of the group consisting of:
(i) an updraft about an interior of said chimney;
(ii) an updraft about an exterior of said chimney; and
(iii) a prevailing wind.

11. The wind and updraft turbine of claim 10, for the generation of electrical power.

12. A method for generating electrical power, the method comprising:
mounting a wind and updraft turbine having a current inducing rotor comprising a current inducing set of permanent magnets rotatable about said upper exterior portion of said chimney, about an axis at least substantially in line with a main axis of said chimney, a stationary, current generating stator comprising at least one wound coil about which said rotor rotates, wherein said rotor generates a magnetic field which passes in close proximity to said at least one wound coil and at least two wind-engaging rotor blades extending outwardly from an outer casing associated with said rotor, wherein each of said at least two wind-engaging blades are movable upon application thereto of an air movement about said chimney selected from at least one of the group consisting of: (i) an updraft about an interior of said chimney; (ii) an updraft about an exterior of said chimney; and (iii) a prevailing wind, at or adjacent an upper exterior portion of a chimney, and wherein said air movement rotates said at least two wind-engaging rotor blades.

13. The wind and updraft turbine of claim 10, wherein said at least two wind-engaging blades are mounted with rotational symmetry about said outer casing associated with said rotor.

14. The wind and updraft turbine of claim 13 wherein a venturi is vertically mounted on said chimney to facilitate said updraft about said exterior of said chimney.

15. The wind and updraft turbine of claim 13 wherein the diameter of said chimney is between a range of approximately 1 inch to 25 feet, and wherein said wind turbine is adaptable to chimneys within said range.

16. The wind and updraft turbine of claim 13 wherein said current generating stator comprises a circular array of wound coils, and wherein said circular array of wound coils extends around a circumference of said chimney and is rigidly attached thereto.

17. The wind and updraft turbine of claim 16 wherein said current inducing rotor comprises a circular array of permanent magnets, and wherein said circular array of permanent magnets extends around a circumference of said stator and is rotatably attached thereto.

18. The wind and updraft turbine of claim 17 wherein said circular array of wound coils and said circular array of permanent magnets are magnetically coupled thereto.

19. The wind and updraft turbine of claim 13 wherein said current generating stator comprises a plurality of circular arrays of wound coils, and wherein said plurality of circular arrays of wound coils extend around a circumference of said chimney and are rigidly attached thereto, and wherein said current inducing rotor comprises a plurality of circular arrays of permanent magnets, and wherein said plurality of circular arrays of permanent magnets extend around a circumference of said chimney and are rotatably attached thereto, and wherein said plurality of circular arrays of wound coils are layered with and in close proximity to said plurality of circular arrays of permanent magnets.

20. The wind and updraft turbine of claim 10, wherein said updraft is caused by any one or more of:
(a) hot emissions from said chimney;
(b) heating of air adjacent said exterior surface of said chimney by conduction of internal heat in said chimney;
(c) heating of air within said chimney and adjacent said exterior surface of said chimney by solar radiation; and
(d) wind hitting and being forced upwards along said exterior of said chimney.

21. A wind turbine mountable at or near an upper exterior portion of a stationary cylindrical pole, said wind turbine comprising:
a current inducing rotor comprising a current inducing set of permanent magnets rotatable about said upper exterior portion of said cylindrical pole, about an axis at least substantially in line with a main axis of said cylindrical pole;
a stationary, current generating stator comprising at least one wound coil about which said current inducing rotor rotates, wherein said current inducing rotor generates a magnetic field which passes in close proximity to said at least one wound coil; and
at least two wind-engaging rotor blades extending vertically from an outer casing associated with said current inducing rotor, wherein each of said at least two wind-engaging blades are movable upon application thereto of a prevailing wind;
wherein said current generating stator comprises a circular array of wound coils, and wherein said circular array of wound coils extends around a circumference of said cylindrical pole and is rigidly attached thereto; and
wherein said current inducing rotor comprises a circular array of permanent magnets, and wherein said circular array of permanent magnets extends around a circumference of said stator and is rotatably attached thereto.

22. The wind turbine of claim 21, wherein said at least two wind-engaging rotor blades are mounted with rotational symmetry about said outer casing associated with said current inducing rotor.

23. A wind turbine mountable at or near an upper exterior portion of a cylindrical pole, said wind turbine comprising:
a current inducing rotor comprising a current inducing set of permanent magnets rotatable about said upper exterior portion of said cylindrical pole, about an axis at least substantially in line with a main axis of said cylindrical pole;
a stationary, current generating stator comprising at least one wound coil about which said current inducing rotor rotates, wherein said current inducing rotor generates a magnetic field which passes in close proximity to said at least one wound coil; and
at least two wind-engaging rotor blades extending vertically from a rotor hub associated with said current inducing rotor, wherein each of said at least two wind-engaging blades are moveable upon application thereto of a prevailing wind;
wherein said current generating stator comprises a plurality of circular arrays of wound coils, and wherein said plurality of circular arrays of wound coils extend around a circumference of said cylindrical pole and are rigidly attached thereto, and wherein said current inducing rotor comprises a plurality of circular arrays of permanent magnets, and wherein said plurality of circular arrays of permanent magnets extend around a circumference of said cylindrical pole and are rotatably attached thereto, and wherein said plurality of circular arrays of wound coils are layered with and in close proximity to said plurality of circular arrays of permanent magnets.

24. The wind turbine of claim 21, wherein said at least two wind-engaging rotor blades are mounted with rotational symmetry about said rotor hub associated with said current inducing rotor.
